(19) United States
(12) Patent Application Publication
(10) Pub. No.: US 2026/0300694 A1
(43) Pub. Date: Oct. 1, 2026

(54) COMPARING AND MERGING GENERATIVE MODEL PROMPTS

(71) Applicant: GDM Holding LLC, Mountain View, CA (US)

(72) Inventors: Florian Nils Hartmann, Zurich (CH); Sian Heather Gooding, London (GB)

(21) Appl. No.: 19/094,642

(22) Filed: Mar. 28, 2025

(51) Int. Cl. G06N 3/0475; G06F 40/284; G06F 40/40

(52) U.S. Cl. CPC G06N 3/0475; G06F 40/284; G06F 40/40

(57) ABSTRACT

This specification describes a method of comparing or merging generative model prompts, the method being implemented using one or more data processing apparatus. The method comprises generating a concept distribution for each of two or more prompts. For each of a plurality of evaluation data items, an input is provided to the generative model, thereby to generate a value for each of a set of one or more activations of the generative model. The input is formed using the prompt and data from the evaluation data item. A concept score is obtained for each of one or more concept items, comprising comparing the values for each of the one or more activations with a concept vector for the concept item. The concept distribution is determined based on the concept scores for the plurality of evaluation data items. The method includes comparing or merging the prompts based on the concept distributions.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes comparing and merging generative model prompts based on concept distributions.

One example implementation described in this specification relates to a method of comparing or merging generative model prompts. The method is implemented using one or more data processing apparatus. The method includes generating a concept distribution for each of two or more prompts. Generating a concept distribution for a prompt comprises, for each of a plurality of evaluation data items: providing an input to the generative model, thereby to generate a value for each of a set of one or more activations of the generative model, wherein the input is formed using the prompt together with data from the evaluation data item. Generating the concept distribution for the prompt further comprises obtaining a concept score for each of one or more concept items, comprising comparing the values for the set of one or more activations with a concept vector for the concept item, and determining the concept distribution based on the concept scores for the plurality of evaluation data items. The method includes comparing or merging the prompts based on the concept distributions.

The set of one or more activations of the generative model may be one or more activations of a preselected layer of the generative model, e.g., a preselected hidden layer of the generative model.

In some implementations, the method comprises comparing the prompts based on the concept distributions. Comparing the prompts based on the concept distributions may comprise subtracting the concept distribution for one of the prompts from the concept distribution for another of the prompts. Alternatively, comparing the prompts based on the concept distributions may comprise subtracting the concept distribution for one of the prompts from an average concept distribution for two or more other of the prompts.

In some implementations, the method includes causing a comparison between the concept distributions to be displayed on a display.

In some implementations, for each concept item, generating the concept vector comprises inputting a concept example for the concept item to the generative model to generate a concept example value for each of the set of one or more activations of the generative model.

In some implementations, comparing the values for each of the one or more activations with a concept vector comprises forming an inner product between a vector formed by the values and the concept vector, wherein the concept vector comprises concept vector values for each of the one or more activations.

In some implementations, the evaluation data items form a data cluster in an evaluation data set, wherein the evaluation data set is clustered based on conceptual similarity.

In some implementations, the method includes obtaining a desired concept distribution using the concept distributions for the prompts, and determining a steering vector for each of one or more concept items represented in the desired concept distribution. Determining each steering vector may comprise identifying a subset of the one or more activations that correlate with the respective concept item and identifying, for each activation in the subset, a respective multiplier. The method may further comprise performing a forward pass of the generative model, comprising, for each steering vector, adjusting the respective subset of one or more activations based on the corresponding multipliers.

In some implementations, the method comprises obtaining a desired concept distribution using the distributions for the prompts, and merging the prompts, comprising performing an optimization process to generate a merged prompt, wherein the optimization goal is for a concept distribution for the merged prompt to match the desired concept distribution.

In some implementations, the generative model is configured to generate a set of embeddings for a given input, wherein the optimization process comprises backpropagating to the set of embeddings, using gradient descent.

In other implementations, the optimization process comprises an evolutionary algorithm.

Another example implementation described in this specification relates to a method of generating a prompt for a generative model. The method is implemented using one or more data processing apparatus. The method includes performing an optimization process to generate an output prompt from an initial input prompt. The optimization process comprises one or more iterations. Each iteration comprises, for each of a plurality of data items: generating a value for each of a set of one or more activations of a generative model using the data item and a current prompt for the iteration, and obtaining a concept score for each of one or more concept items. Obtaining a concept score for a concept item comprises comparing the values for the set of one or more activations with a concept vector for the concept item. The method includes generating a concept distribution for the iteration based on the concept scores for the plurality of data items, and updating the current prompt for the iteration. Updating the current prompt for the iteration comprises backpropagating to a set of one or more embeddings of the current prompt for the iteration based on a loss function comprising a comparison between the concept distribution for the iteration and a desired concept distribution.

The set of one or more activations may comprise one or more activations of a steering layer of the generative model. The steering layer may comprise a hidden layer.

The loss function may comprise a fluency loss.

This specification also describes a system comprising one or more data processing apparatus and a memory. The memory stores instructions that when executed by the one or more data processing apparatus, causes the one or more data processing apparatus to carry out any of the methods described in this specification.

This specification also describes a non-transitory computer-readable storage medium comprising instructions that when executed by one or more data processing apparatus causes the one or more data processing apparatus to carry out any of the methods described in this specification.

It will be appreciated that features described in the context of one aspect may be combined with features of one or more other aspects.

Particular embodiments of the subject matter described in this specification can be implemented so as to realize one or more of the following advantages.

Various example implementations described in this specification provide a technical contribution to the field of prompt engineering by providing a tool to assist prompt engineers in evaluating the effects of different generative model prompts. In particular, generating and comparing concept distributions for prompts provides an improved understanding of the differences between prompts compared to existing evaluation methods. Moreover, various example implementations described in this specification provide a further technical contribution to the field of prompt engineering by providing a tool to merge prompts together to form a new, merged prompt, or more generally to generate prompts which have desired effects when used to prompt a generative model. Generating better prompts improves the quality of the result that is obtained using generative models. Various example implementations described in this specification find high quality prompts in fewer iteration steps compared to other methods which do not employ the techniques described in this specification.

As used herein, a “concept item” generally refers to a semantic construct, characteristic, attribute, theme, or quality that is relevant to the analysis or generation of output by the generative model. Examples include politeness, conciseness, formality, optimism, urgency etc. Concept items serve as targets for understanding or influencing the model's behavior via prompts. For illustrative purposes, concept items might represent stylistic attributes, emotional tone, topical relevance, or other discernible aspects of the generated output or the model's internal processing. Each concept item is typically associated with a corresponding representation, such as a concept vector, used for its detection or measurement within the model.

As used herein, a “concept vector” generally serves as a representation that encodes or corresponds to a specific concept item (e.g., politeness, conciseness) within a particular vector space associated with a generative model, typically the space defined by a set of the model's activations. It provides a reference point for measuring the presence or strength of the concept item in the model's processing. In various implementations, a concept vector may take the form of a numerical vector having dimensions corresponding to a preselected set of activations. Concept vectors may be generated through various techniques. For example, a concept vector may be generated based on concept examples, which may comprise generative model inputs known to exhibit the particular concept (e.g., politeness, conciseness), by processing these examples through the generative model, extracting relevant activation values, and aggregating these values (e.g., through averaging or other statistical methods). Alternatively, or in addition, concept vectors can be identified or generated using other computational analysis techniques applied to the model's activations, such as unsupervised learning methods (which may include, for instance, sparse autoencoder analysis, clustering, or dimensionality reduction) aimed at discovering salient directions or representations within the activation space that correlate with discernible concepts.

As used herein, a “concept score” may be a value, e.g., a scalar, that quantifies or indicates the degree of presence, activation, or alignment related to a particular concept item during the generative model's processing of a specific input (the input often being formed using a prompt and evaluation data). A concept score is typically obtained by performing a comparison between a representation derived from the model's state (e.g., the vector of activation values from a preselected set of activations for the given input) and the concept vector associated with the concept item. The specific comparison operation can vary; for instance, it may involve computing an inner product (such as a dot product), a similarity measure (e.g., cosine similarity), a distance metric, or applying another function designed to assess the relationship between the activation state and the concept vector. The resulting score provides a quantitative measure related to the concept item for that specific input instance.

As used herein, a “concept distribution” provides a characterization of how one or more concept items are manifested across a plurality of evaluation data items when processed using a specific prompt. It is generally derived from the individual concept scores obtained for each concept item over the set of evaluation data items. A concept distribution serves to summarize the overall effect or behavior induced by the prompt with respect to the concept item(s) across a range of inputs. The representation of a concept distribution can take many forms, depending on the analysis needs and the nature of the scores. Examples of representations include, but are not limited to: (i) an empirical distribution (e.g., represented by the collection of scores itself or an empirical cumulative distribution function); (ii) a summarized representation like a histogram, which groups scores into bins and shows frequencies or densities; (iii) a set of descriptive statistics (e.g., mean, median, variance, skewness, quantiles); or (iv) parameters of a theoretical probability distribution fitted to the observed scores. When multiple concept items are considered, the concept distribution may comprise an appropriate multi-variate distribution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for comparing prompts according to an example implementation.

FIG. 2 shows an example system for determining a desired concept distribution according to an example implementation.

FIG. 3 shows an example system for generating an output prompt from an input prompt using a prompt optimization subsystem.

FIG. 4 is a flow diagram illustrating an example method for comparing or merging prompts.

FIG. 5 is a flow diagram illustrating an example method for generating a prompt for a generative model.

Like reference numbers and designations in the various drawings indicate like elements.

### DETAILED DESCRIPTION

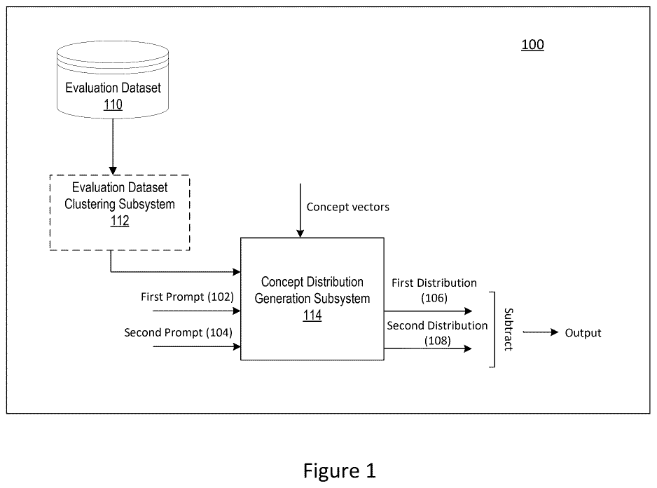

FIG. 1 shows an example system 100 for comparing prompts according to an example implementation.

As used herein, the term “prompt” refers to a part or the whole of an instruction, or other input, for guiding a generative model. The generative model may comprise any machine learning model that is capable of generating an output dependent on a prompt, e.g., any sequence model. For example, the generative model may comprise a model suitable for generating text, image(s), video and/or audio based on an input that is formed using the prompt. In various implementations, the generative model may comprise: a language model such as a large language model (LLM), an image or video generation model, an audio generation model, or a multimodal model such as a vision language model (VLM). In some examples, the prompt may be included in the input of the generative model. Alternatively, the prompt may be processed in one or more preprocessing stages in order to generate an input for the generative model.

The generative model may comprise a neural network that employs one or more layers of nonlinear units to generate an output for a received input. Some neural networks include one or more hidden layers in addition to an output layer. The output of each hidden layer is used as an input to another layer in the network, e.g., the next hidden layer or the output layer. Each nonlinear unit generates its output in accordance with an activation function, and the outputs of the nonlinear units are referred to as activations.

The system 100 of FIG. 1 is configured to compare two prompts 102, 104. Each prompt 102, 104 may comprise text which includes an instruction, e.g., an instruction to generate an email based on data provided by a user. The prompt may comprise a template prompt which includes one or more placeholders for data (e.g., one or more variables or references). In some examples, the prompt may comprise a system prompt intended to guide the overall behaviour of the generative model. In other examples, a system prompt may be combined with the prompt 102, 104 to form the input that is provided to the generative model.

As shown in FIG. 1, the system 100 has access to an evaluation data set 110, which may for example comprise a plurality of data items that may be used in conjunction with the first or second prompts 102, 104 to generate a draft of an email. For instance, each data item may comprise text (e.g., freeform text) that is provided by a user and which is not in the form of an email. The first and second prompts may each comprise an instruction to generate a draft of an email based on <data item>, where <data item> is a placeholder for a data item from the evaluation data set.

The first and second prompts are different to one another, e.g., each may be drafted in a different way with different emphasis and/or with different terms, and these differences may result in differences in the corresponding draft email that is generated when the generative model is prompted using that prompt. The system 100 is configured to analyse the relative effects that the different prompts have on the eventual email drafts that are generated. In particular, as described in more detail below, the system 100 generates a respective concept distribution 106, 108 for each of the first and second prompts 102, 104, and compares the generated concept distributions to provide a measure of the relative effect of the first and second prompts across one or more concept items. In this way, a prompt engineer may use the system 100 to compare two different prompts. To give an example, an output of the system 100 might show that the first prompt produces more polite emails than the second, or that the second prompt produces more concise emails than the first, etc.

The concept distribution is generated based on a set of one or more concept vectors. Each concept vector may be generated using a respective set of example generative model inputs that each exhibit a particular concept. For example, the respective set of example generative model inputs for a “politeness” concept vector may each generate emails that are considered polite. The respective set of example generative model inputs for a “conciseness” concept vector may each generate emails that are considered concise.

Each concept vector may be obtained by inputting each example generative model input in the respective set into the model and performing a forward pass. The values of a preselected set of activations of the generative model are then stored. The preselected set of activations may for example comprise a set of activations from a preselected layer of the generative model. The preselected layer may also be referred to herein as the “steering layer”. Any suitable layer may be chosen as the steering layer, depending on the choice of system design: generally, earlier layers better encode lower-level concepts while later layers encode higher-level concepts. The concept vector may be determined by averaging the values of the preselected set of activations across the example generative model inputs in the set. Concept vectors may alternatively be determined in other ways, e.g., using unsupervised techniques based on sparse autoencoders. Reference is directed to “Improving Dictionary Learning with Gated Sparse Autoencoders”, S. Rajamanoharan, et al., arXiv:2404.16014v2 [cs:LG] 30 Apr. 2024.

As shown, the system 100 may optionally include an evaluation dataset clustering subsystem 112 to cluster the evaluation dataset into a number of clusters. Techniques for clustering data are known per se and will not be described here. The clusters may be formed such that the data items are clustered based on a given measure of similarity. In some cases, the clustering may be biased based on one or more of the concept vectors discussed above, i.e., clusters may be determined such that each example in the cluster activates a similar concept. This allows the system to make comparisons specific to particular concepts, e.g., “when emails are phrased in a polite way, how do the prompts otherwise differ”.

The system 100 includes a concept distribution generation subsystem 114 which is configured to generate the respective concept distributions 106, 108 for the prompts 102, 104. Each cluster may be considered by the subsystem 114 individually. That is, for each prompt 102, 104, a concept distribution may be generated using the data items in a particular cluster. For each data item in the cluster, a forward pass of the generative model is performed using the given prompt. The resulting values for the preselected set of activations are compared with the concept vectors. For example, an inner product (e.g., dot product) may be computed between the resulting values and each concept vector. This provides a measure of alignment with each concept vector. For example, it may be determined that the resulting values activate the concept of “being polite” by 0.7 (out of 1.0) and the concept of “verbose email” by 0.25 (out of 1.0).

Since a comparison with the one or more concept vectors is performed for each data item in the cluster, a concept distribution may be obtained. For example, the distribution may reflect that 10% of examples activate “being polite” between 0.0 and 0.1, 20% of examples activate the concept between 0.1 and 0.2, etc. In the case that each data item is compared with more than one concept vector, the concept distribution may comprise an appropriate multi-variate distribution. Such multi-variate distributions, as well as techniques for appropriately representing them in a suitable form for data processing, are well known per se to those skilled in the art.

The system compares the concept distributions 106, 108 that each prompt 102, 104 resulted in. For example, the system 100 may subtract the concept distributions from one another. Alternatively, or in addition, the concept distributions 106, 108 may be compared using statistical significance techniques, wherein differences for which statistical significance cannot be detected may be ignored. Suitable statistical significance techniques for comparing distributions are well known per se to those skilled in the art.

To give an example, comparing the concept distributions 106, 108 for the first and second prompts 102, 104 may indicate that, for a particular cluster of data items, the first prompt produces more verbose emails than the second and/or that the first prompt produces more polite emails than the second.

The difference in distributions may be displayed to a user on a display, e.g., using an appropriate visualization technique. Alternatively, or in addition, the difference in distributions may be provided to a language model (e.g., a large language model) together with a prompt to generate a description of what the difference in distribution shows, thus synthesizing the difference in distributions into a natural language description.

Note that comparing distributions provides a significantly improved understanding of the differences between prompts, compared to merely comparing averages. For example, consider two distributions of politeness scores in which the politeness score is between 0 and 1. In a first distribution, the score 0 occurs in 50% of cases and the score 1 occurs in 50% of cases. In a second distribution, the score 0.5 occurs in 100% of cases. The two distributions have the same average but the prompts produce very different results: in the first case, the prompt produces an output which is either very polite or very impolite, whereas in the second case the output is perfectly average in terms of politeness.

In some examples, only a selection of the differences between distributions may be shown to users. For example, differences may be shown only for the concepts with the most significant differences (e.g., the top N differences). Alternatively, a determination may be made of the top N concepts activated by the first prompt 102, and the top M concepts activated by the second prompt 104, and the differences may be shown for these N+M concepts.

Although FIG. 1 illustrates comparison between a first prompt 102 and a second prompt 104, more generally a comparison could be made between any two or more prompts. For example, given a set of three or more prompts, a pairwise comparison may be made by comparing the distributions formed using each pair. Alternatively, one of the prompts may be compared with the average of the distributions formed using the other prompts.

In another example implementation, a system for merging prompts is provided.

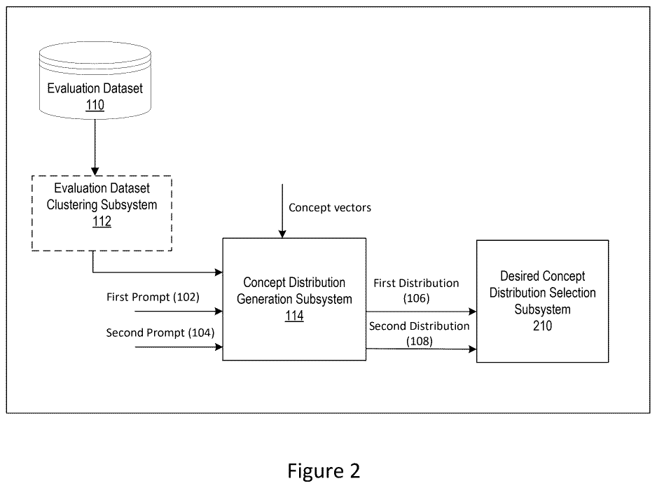

As described in more detail below, prompts may be merged so as to achieve a desired concept distribution. In some examples, the desired concept distribution may be the average of the concept distributions of the prompts to be merged. For instance, instead of subtracting the distributions 106, 108 formed for two prompts 102, 104 as shown in FIG. 1, the two distributions 106, 108 may be averaged to form a “merged” distribution. In an alternative implementation, which is shown in FIG. 2, the two distributions 106, 108 may be input into a concept distribution selection subsystem 210, which may select which parts of the distributions 106, 108 to merge e.g., in accordance with the choice of a user. For example, the concept distribution selection subsystem 210 may cause a visualization of the distributions 106, 108 to be displayed on a screen to the user, and the user may interact with the visualization, via an appropriate user interface, in order to select which parts of the distributions 106, 108 should be merged, thereby to form a desired concept distribution.

In some embodiments, prompts may be merged by packaging the desired concept distribution into a set of steering vectors. Determining a steering vector may comprise looking up the indices of a set of activations for the concept that the steering vector relates to. For example, the relevant set of indices for a particular concept may be determined using the concept vector for that concept. A multiplier may be determined based on the prominence of the concept in the distribution. The set of activations for the concept, together with the multiplier, determine the steering vector for the concept. The set of steering vectors may then be used to amplify the corresponding activations accordingly during a forward pass.

While this approach to merging prompts is relatively simple, it is not transferrable between models that have different weights or architectures. However, in some example implementations, a system for merging prompts is provided which is transferrable between models. This is achieved by generating a new merged prompt which has the desired concept distribution, as described below.

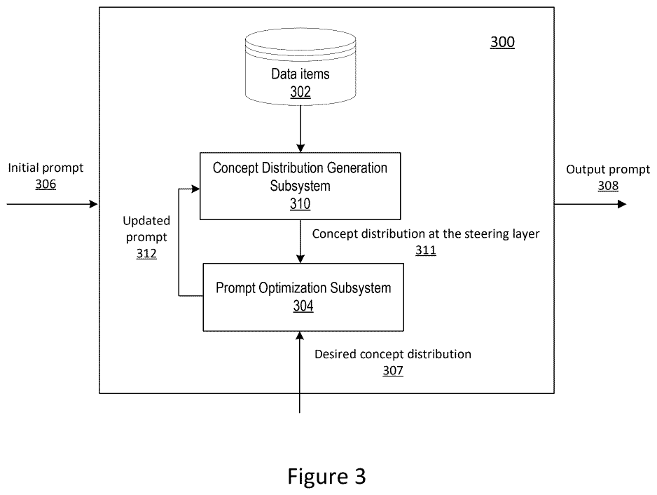

FIG. 3 shows an example system 300 which is configured to generate a new prompt (e.g., merged prompt) having a desired concept distribution. As shown, the system 300 has access to a plurality of data items 302, which may for example comprise the evaluation data set 110 described above with reference to FIG. 1, or a subset (e.g., cluster) thereof. As discussed above, each data item may thus comprise text (e.g., freeform text) that is provided by a user and which is not in the form of an email.

The system 300 includes a prompt optimization subsystem 304, which is configured to adapt an initial prompt 306 using an optimization process. The initial prompt may for example comprise the first prompt 102 or the second prompt 104. The objective of the optimization process is to adapt the initial prompt such that the concept distribution at the steering layer matches the desired concept distribution 307. The initial prompt is iteratively adapted by the prompt optimization subsystem 304 to form an output prompt 308.

The system 300 includes a concept distribution generation subsystem 310 which is configured to form the concept distribution 311 at the steering layer. For each data item, a forward pass of the generative model is performed using the current version of the prompt. The resulting values for the preselected set of activations at the steering layer are compared with the one or more concept vectors. For example, an inner product (e.g., dot product) may be computed between the resulting values and each concept vector. Since a comparison with the one or more concept vectors is performed for each of the data items 302, a concept distribution 311 may be obtained at the steering layer.

At a given iteration, the generative model forms a set of embeddings for the current prompt by tokenizing the text of the prompt and looking up the embedding for each token in a lookup table. To optimize the prompt, the prompt optimization subsystem 304 performs backpropagation to the set of prompt embeddings, with the objective of minimizing the difference between the concept distribution at the steering layer and the desired concept distribution. Thus, the set of prompt embeddings, rather than the weights of the generative model, are updated by the backpropagation process. As will be understood by those skilled in the art, an appropriate loss function, such as Kullback-Leibler (KL) divergence, may be used in the optimization process.

The prompt optimization subsystem decodes the updated prompt embedding to form an updated prompt 312. This may be done by matching each embedding in the updated set of prompt embeddings to the closest token embedding. Methods for achieving this include: sampling between the tokens to pick which one to optimize, or using the Gumbel-Softmax “trick” as described in Jang, et al., “Categorical Reparameterization with Gumbel-Softmax”, arXiv:1611.01144 [stat.ML].

The current prompt is replaced with the updated prompt and the process then iterates by performing a new forward pass, comparing the concept distribution at the steering layer to the desired concept distribution, backpropagating to the embeddings, and decoding the updated embeddings to update the prompt again.

To ensure the prompt remains human readable, a fluency loss may be added to the optimization process.

Iterations continue until one or more convergence criteria are reached, or a certain number of iterations have been performed, thereby forming the eventual output prompt 308, which may be displayed to the user.

In examples in which it is not important for the prompt to be human-readable, the fluency loss may be omitted. In this case, the prompt optimization subsystem 304 may perform backpropagation to a soft prompt.

Further alternatively, in some examples an evolutionary algorithm may be used instead of backpropagation. In such an evolutionary approach, the system may maintain a population of prompts, which is evolved whilst evaluating a fitness function based on how well the prompts match the desired concept distribution.

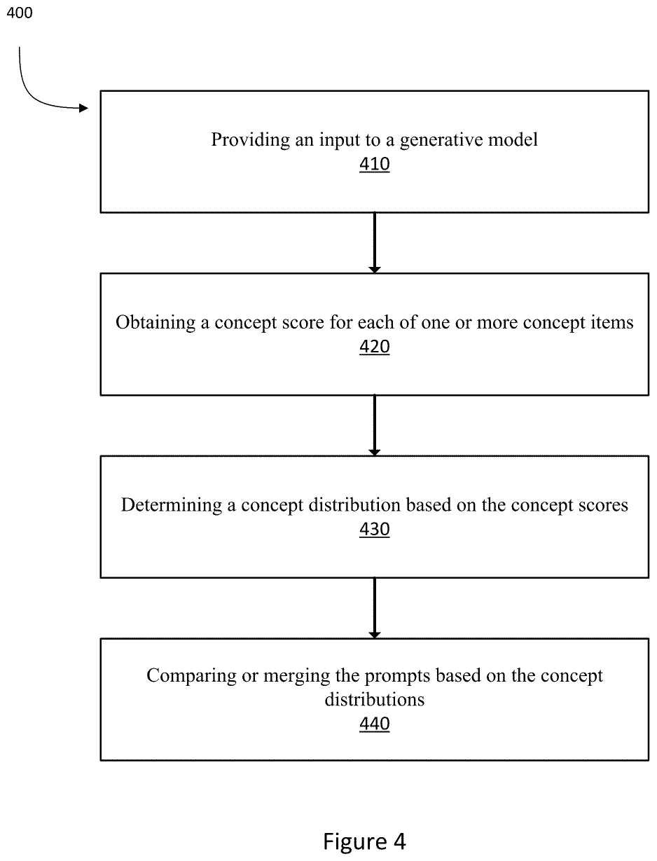

FIG. 4 is a flow diagram illustrating an example method 400 for comparing or merging generative model prompts in accordance with an example implementation. The method comprises generating a concept distribution for each of two or more prompts, and comparing or merging the prompts based on the corresponding concept distributions.

For a given prompt, a concept distribution is generated by providing 410 an input to the generative model. The input is formed using the prompt, together with data from the evaluation data item. For example, the prompt may comprise a template prompt having a placeholder for the evaluation data item.

The input is processed by the generative model in a forward pass, and a value is generated for each of a set of one or more activations. The set of one or more activations may be one or more activations of a preselected steering layer.

A concept score is obtained 420 for each of one or more concept items. For example, a concept score may be obtained for politeness, conciseness etc. More generally, a concept score may be obtained for any concept item for which a concept vector has previously been determined.

Obtaining a concept score for each of the one or more concept items comprises comparing values for the set of one or more activations with a concept vector for the concept item. For example, for a given concept item, the concept score may be the inner product (e.g., dot product) between the values for the set of one or more activations and the concept vector for the concept item.

A concept distribution is then determined 430 based on the concept scores.

The prompts are then compared or merged 440 based on the concept distributions. For example, to compare the prompts, the concept distributions may be subtracted. To combine the prompts, the concept distributions may be averaged.

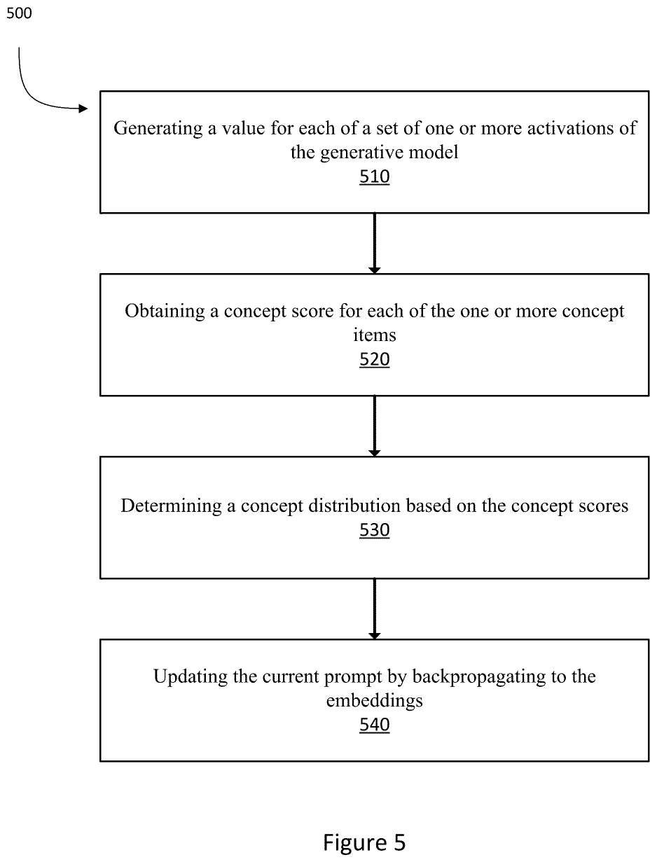

FIG. 5 is a flow diagram illustrating an example method 500 for generating a prompt for a generative model. The method 500 comprises performing an optimization process to generate an output prompt from an initial input prompt.

The optimization process comprises one or more iterations. At each iteration, a concept distribution is generated based on the current prompt for the iteration. Generating the concept distribution comprises, for each of a plurality of data items (e.g., evaluation data items), generating 510 a value for each of a set of one or more activations of the generative model using the data item and current prompt for the iteration. A concept score is obtained 520 for each of the one or more concept items. Obtaining the concept score comprises comparing the values for the set of one or more activations with a concept vector for the concept item. The concept distribution for the iteration is generated 530 based on the values for the set of one or more activations.

The current prompt for the iteration is then updated 540. Updating the current prompt for the iteration comprises backpropagating to a set of one or more embeddings of the current prompt for the iteration based on a loss function. The loss function reflects a comparison between the concept distribution for the embedding and the desired concept distribution.

Further details regarding LLMs will now be described. An LLM can be an auto-regressive neural network that generates each token in an output sequence conditioned on the preceding tokens in the output sequence and at least some of the tokens in an input sequence.

For example, the LLM can be configured to process an input sequence of tokens from a vocabulary of tokens to generate an output sequence of tokens from the vocabulary.

As part of its processing, the LLM may generate embeddings for the tokens using known techniques, e.g., by looking up the embedding for each token in a lookup table.

More generally, an LLM generative machine learning model can be any appropriate neural network that receives an input sequence made up of tokens selected from a vocabulary and auto-regressively generates an output sequence made up of tokens from the vocabulary. For example, the generative machine learning model can be a Transformer-based neural network or a recurrent neural network-based neural network.

In some situations, the generative machine learning model can be referred to as an auto-regressive neural network when the neural network used to implement the neural network auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the generative machine learning model can process the current input sequence to generate a score distribution (e.g., a probability distribution) that assigns a respective score, e.g., a respective probability, to each token in the vocabulary of tokens. The generative machine learning model can then select, as the particular token, a token from the vocabulary using the score distribution. For example, the generative machine learning model can greedily select the highest-scoring token or can sample, e.g., using nucleus sampling or another sampling technique, a token from the distribution.

As a particular example, the generative machine learning model can be an auto-regressive Transformer-based neural network that includes (i) a plurality of attention blocks, at least some of which apply a self-attention operation and (ii) an output subnetwork that processes an output of the last attention block to generate the score distribution.

The generative machine learning model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv:2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv:2005.14165, 2020. All of which are hereby incorporated by reference in their entirety.

The generative machine learning model can undergo a first phase of pre-training followed by a second phase of fine-tuning. In general, a generative machine learning model such as an LLM can be pre-trained on large amounts of data including data from, but not limited to, webpages, electronic books, software code, electronic news articles, and machine translation data. The generative machine learning model can be pre-trained using unsupervised or self-supervised learning. For example, the generative machine learning model can be pre-trained on a next token prediction task and/or a masked token prediction task. Pre-training on large quantities of diverse data can provide the generative machine learning model with remarkable natural language reasoning capabilities.

Following pre-training, the generative machine learning model can undergo fine-tuning to improve the model's ability to respond to user prompts and queries. Two example types of fine-tuning techniques are supervised fine-tuning (SFT) and reinforcement learning with human feedback (RLHF).

In SFT, a high-quality dataset including examples of input prompts and corresponding responses can be used. This data is typically generated by human annotators. The generative machine learning model can be trained using supervised learning to generate the corresponding responses from the input prompt. SFT requires a much smaller amount of data that used in pre-training.

In RLHF, a reward model can be trained from human preference data regarding different outputs generated from the same input prompt. That is, given an input prompt, different outputs are generated using different models. The models can be a copy of the generative machine learning model with different parameters obtained through checkpointing during pre-training or the models could be entirely unrelated. The input prompt and the different outputs are shown to human assessors and the human assessors are asked to rank the outputs in order of preference with respect to the input prompt. This can be repeated with many different input prompts to generate a dataset of preference data. A reward model can be trained on this preference data to provide a scalar preference value (a “reward” value) for a particular input prompt and generated output pair. The reward model can be based on the generative machine learning model with an additional head for generating the scalar value for example.

The generative machine learning model undergoing training can then be fine-tuned using reinforcement learning based upon the reward values provided by the trained reward model. That is, for a given training prompt, the generative machine learning model generates an output which can be evaluated using the reward model. The parameters of the generative machine learning model can be adjusted using a reinforcement learning update rule based upon the reward value provided by the reward model. In some implementations, a reinforcement learning update rule based upon the Proximal Policy Optimization (PPO) algorithm is used with the generative machine learning model acting as the “policy”.

Through such training, it is possible that a generative machine learning model can respond to user queries and instructions in a zero-shot manner, for example, by including appropriate instructions and examples in the prompt provided to the generative machine learning model without the need for further extensive fine-tuning. For example, an LLM-based generative machine learning model can be prompted to caption an input image or other data item.

It will be appreciated that the above is not limited to processing text tokens only. In some implementations, an LLM can process and generate tokens of other modalities including image tokens, audio tokens and video tokens. These models are sometimes also referred to as Visual Language Models (VLMs) or multi-modal language models or some variation of such terms. An example of these multi-modal models includes the Gemini family of models, further details of which can be found in Google Gemini Team, “Gemini: a family of highly capable multimodal models.” arXiv preprint arXiv:2312.11805 (2023) which is hereby incorporated by reference in its entirety. A further example is PaliGemma 2, further details of which can be found in Steiner, Andreas, et al., “PaliGemma 2: A Family of Versatile VLMs for Transfer.” arXiv preprint arXiv:2412.03555 (2024) which is hereby incorporated by reference it is entirety.

It will be appreciated that the above also applies for any autoregressive neural network that is used in the data generation process. An example of an autoregressive neural network for audio generation is AudioLM, further details of which can found in Z. Borsos, et al., “Audiolm: a language modeling approach to audio generation.” IEEE/ACM transactions on audio, speech, and language processing 31 (2023): 2523-2533 which is hereby incorporated by reference in its entirety.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. These processes and logic flows can be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can utilize any type of central processing unit (CPU) graphics processing units (GPUs), tensor processing units (TPUs), and other machine learning accelerators. GPUs, TPUs, and other machine learning accelerators may be employed to enhance performance, particularly for tasks involving artificial intelligence and machine learning. These accelerators may work in conjunction with CPUs, handling specialized computations while the CPU manages overall system operations and other tasks. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of comparing or merging generative model prompts, the method being implemented using one or more data processing apparatus and comprising:
generating a concept distribution for each of two or more prompts, comprising:
for each of a plurality of evaluation data items:
providing an input to the generative model, thereby to generate a value for each of a set of one or more activations of the generative model, wherein the input is formed using the prompt together with data from the evaluation data item, and
obtaining a concept score for each of one or more concept items,
comprising comparing the values for the set of one or more activations with a concept vector for the concept item, and
determining the concept distribution based on the concept scores for the plurality of evaluation data items, and
comparing or merging the prompts based on the concept distributions.

2. The method of claim 1, comprising comparing the prompts based on the concept distributions, wherein comparing the prompts based on the concept distributions comprises subtracting the concept distribution for one of the prompts from the concept distribution for another of the prompts.

3. The method of claim 1, comprising comparing the prompts based on the concept distributions, wherein comparing the prompts based on the concept distributions comprises subtracting the concept distribution for one of the prompts from an average concept distribution for two or more other of the prompts.

4. The method of claim 1, further comprising causing a comparison between the concept distributions to be displayed on a display.

5. The method of claim 1, wherein for each concept item, the concept vector is generated by a process comprising inputting a concept example for the concept item to the generative model to generate a concept example value for each of the set of one or more activations of the generative model.

6. The method of claim 1, wherein comparing the values for each of the one or more activations with a concept vector comprises forming an inner product between a vector formed by the values and the concept vector, wherein the concept vector comprises concept vector values for each of the one or more activations.

7. The method of claim 1, wherein the evaluation data items form a data cluster in an evaluation data set, wherein the evaluation data set is clustered based on conceptual similarity.

8. The method of claim 1, comprising:
obtaining a desired concept distribution using the concept distributions for the prompts;
determining a steering vector for each of one or more concept items represented in the desired concept distribution, wherein determining each steering vector comprises:
identifying a subset of the one or more activations that correlate with the respective concept item, and
identifying, for each activation in the subset, a respective multiplier, and
performing a forward pass of the generative model, comprising, for each steering vector, adjusting the respective subset of one or more activations based on the corresponding multipliers.

9. The method of claim 1, further comprising:
obtaining a desired concept distribution using the distributions for the prompts, and
merging the prompts, comprising performing an optimization process to generate a merged prompt, wherein the optimization goal is for a concept distribution for the merged prompt to match the desired concept distribution.

10. The method of claim 9, wherein the generative model is configured to generate a set of embeddings for a given input, wherein the optimization process comprises backpropagating to the set of embeddings.

11. The method of claim 9, wherein the optimization process comprises an evolutionary algorithm.

12. A method of generating a prompt for a generative model, the method being implemented using one or more data processing apparatus and comprising:
performing an optimization process to generate an output prompt from an initial input prompt, wherein the optimization process comprises one or more iterations, each iteration comprising:
for each of a plurality of data items:
generating a value for each of a set of one or more activations of a generative model using the data item and a current prompt for the iteration, and
obtaining a concept score for each of one or more concept items, comprising comparing the values for the set of one or more activations with a concept vector for the concept item, and
generating a concept distribution for the iteration based on the concept scores for the plurality of data items, and
updating the current prompt for the iteration, comprising backpropagating to a set of one or more embeddings of the current prompt for the iteration based on a loss function comprising a comparison between the concept distribution for the iteration and a desired concept distribution.

13. The method of claim 12, wherein the set of one or more activations comprise one or more activations of a hidden layer of the generative model.

14. A system comprising:
one or more data processing apparatus; and
a memory storing instructions that when executed by the one or more data processing apparatus cause the one or more data processing apparatus to carry out a method comprising:
for each of two or more prompts, generating a concept distribution, comprising:
for each of a plurality of evaluation data items:
providing an input to the generative model, thereby to generate a value for each of a set of one or more activations of the generative model, wherein the input is formed using the prompt together with data from the evaluation data item, and
obtaining a concept score for each of one or more concept items, comprising comparing the values for each of the one or more activations with a concept vector for the concept item, and
determining the concept distribution based on the concept scores for the plurality of evaluation data items, and
comparing or merging the prompts based on the concept distributions.

15. The system of claim 14, comprising comparing the prompts based on the concept distributions, wherein comparing the prompts based on the concept distributions comprises subtracting the concept distribution for one of the prompts from the concept distribution for another of the prompts.

16. The system of claim 14, comprising comparing the prompts based on the concept distributions, wherein comparing the prompts based on the concept distributions comprises subtracting the concept distribution for one of the prompts from an average concept distribution for two or more other of the prompts.

17. The system of claim 14, further comprising causing a comparison between the concept distributions to be displayed on a display.

18. The system of claim 14, wherein for each concept item, the concept vector is generated by inputting a concept example for the concept item to the generative model to generate a concept example value for each of the set of one or more activations of the generative model.

19. The system of claim 14, wherein comparing the values for each of the one or more activations with a concept vector comprises forming an inner product between a vector formed by the values and the concept vector, wherein the concept vector comprises concept vector values for each of the one or more activations.

20. A system comprising:
one or more data processing apparatus; and
a memory storing instructions that when executed by the one or more data processing apparatus cause the one or more data processing apparatus to carry out a method comprising:
performing an optimization process to generate an output prompt from an initial input prompt, wherein the optimization process comprises one or more iterations, each iteration comprising:
for each of a plurality of data items:
generating a value for each of a set of one or more activations of a generative model using the data item and a current prompt for the iteration,
obtaining a concept score for each of one or more concept items,
comprising comparing the values for the set of one or more activations with a concept vector for the concept item,
generating a concept distribution for the iteration based on the concept scores for the plurality of data items, and
updating the current prompt for the iteration, comprising backpropagating to a set of one or more embeddings of the current prompt for the iteration based on a loss function comprising a comparison between the concept distribution for the iteration and a desired concept distribution.
